(19) United States
(12) Patent Application Publication
(10) Pub. No.: US 2014/0190726 A1
(43) Pub. Date: Jul. 10, 2014

(54) MIXTURE OF DECAFLUORO-2-METHYLBUTAN-3-ONE AND A CARRIER GAS AS A MEDIUM FOR ELECTRICAL INSULATION AND/OR FOR ELECTRIC ARC EXTINCTION IN MEDIUM-VOLTAGE

(71) Applicants: Yannick Kieffel, Saint-Jean-de-Bournay (FR); Alain Girodet, Chassieu (FR); Daniel Piccoz, Lucenay (FR)

(72) Inventors: Yannick Kieffel, Saint-Jean-de-Bournay (FR); Alain Girodet, Chassieu (FR); Daniel Piccoz, Lucenay (FR)

(73) Assignee: SCHNEIDER ELECTRIC INDUSTRIES SAS, Rueil Malmaison (FR)

(21) Appl. No.: 14/119,352

(22) PCT Filed: May 24, 2012
(86) PCT No.: PCT/EP2012/059750

§ 371 Date: Feb. 11, 2014

(30) Foreign Application Priority Data
May 24, 2011 (FR) 11 54517

(51) Int. Cl. H01B 3/56

(52) U.S. Cl. CPC H01B 3/56
USPC 174/17 GF; 252/571

(57) ABSTRACT

The invention relates to the use of a mixture comprising decafluoro-2-methylbutan-3-one and a carrier gas or dilution gas as a medium for electrical insulation and/or for extinction of electric arcs in a medium- or high-voltage electrical device.

It also relates to a medium- or high-voltage electrical device in which electrical insulation and/or extinction of electric arcs is/are implemented by a mixture comprising decafluoro-2-methylbutan-3-one and a carrier gas or dilution gas.

Applications: electrical transformers, gas-insulated lines for transporting or distributing electricity, set of busbars, electrical connection/disconnection devices (circuit breakers, switches, switch-fuse sets, disconnectors, earthing switches, contactors, etc.).

### TECHNICAL FIELD

The present invention relates to the field of electrical insulation and of extinction of electric arcs in medium- or high-voltage electrical devices.

More specifically, it relates to the use of a mixture comprising a particular fluoroketone, namely decafluoro-2-methylbutan-3-one, and a carrier gas such as air, nitrogen or carbon dioxide, as a medium for electrical insulation and/or for extinction of electric arcs in a medium- or high-voltage electrical device.

It also relates to a medium- or high-voltage electrical device in which electrical insulation and/or extinction of electric arcs is/are implemented by a mixture comprising decafluoro-2-methylbutan-3-one and a carrier gas.

This electrical device may notably be an electrical transformer such as a power or measurement transformer, a gas-insulated line (GIL) for transporting or distributing electricity, a set of busbars or again an electrical connection/disconnection device (also called a swithgear), such as a circuit breaker, a switch, a switch-fuse set, a disconnector, an earthing switch or a contactor.

### STATE OF THE PRIOR ART

In medium- or high-voltage electrical devices, electrical insulation and, if applicable, extinction of electric arcs are typically implemented by a gas which is confined within these devices.

In the foregoing and in what follows the terms “medium-voltage” and “high-voltage” are used in their habitual acceptance, namely that the term “medium-voltage” designates a voltage of over 1,000 volts for alternating current, and over 1,500 volts for direct current, but which does not exceed 52,000 volts for alternating current and 75,000 volts for direct current, whereas the term “high-voltage” designates a voltage which is strictly greater than 52,000 volts for alternating current and greater than 75,000 volts for direct current.

The gas most often used in this type of device is currently sulphur hexafluoride (SF₆). This gas indeed has relatively high dielectric strength, satisfactory thermal conductivity and low dielectric losses. It is chemically inert and non-toxic for humans and animals and, after having been associated by an electric arc it recombines rapidly and almost completely. In addition, it is non-flammable and its price is, even today, moderate.

However, one major disadvantage of SF₆ is that it has a global warming potential (GWP) of 22,800 (relative to CO₂ over 100 years), and an atmosphere residence time of 3,200 years, making it one of the gases with a strong greenhouse effect.

SF₆ was therefore included by the Kyoto Protocol (1997) in the list of gases the emissions of which must be restricted.

The best means of restricting emissions of SF₆ consists in limiting the use of this gas, which has led industrial companies to seek alternatives to SF₆.

So-called “simple” gases, such as air or nitrogen, which have no negative environmental impact, have a much lower dielectric strength than that of SF₆. Thus, for example, the dielectric strengths in alternating voltage (50 Hz) of air and nitrogen are roughly one third than that of SF₆.

The use of these simple gases for electrical insulation and/or extinction of electric arcs in medium- or high-voltage electrical devices consequently implies that the volume or filling pressure of these devices must be increased drastically, which runs counter to the efforts made over the past decades to develop compact electrical devices, taking up increasingly small volumes.

Mixtures of SF₆ and nitrogen are used to restrict the impact of SF₆ on the environment. Indeed, the addition of SF₆ at a rate of 10 to 20% by volume may significantly improve the dielectric strength of nitrogen.

However, due to the high GWP of SF₆, the GWP of these mixtures remains very high. Thus, for example, a mixture of SF₆ and nitrogen in a 10/90 volume ratio has an alternating voltage (50 Hz) dielectric strength equal to 59% of that of SF₆, but its GWP is of the order of 8,000 to 8,650.

Such mixtures cannot therefore be used as gases with low environmental impact.

The same applies to perfluorocarbons which have, generally, useful dielectric strength properties, but the GWPs of which are typically within a range of 5,000 to 10,000 (6,500 for CF₄, 7,000 for C₃F₈ and C₄F₁₀, 8,700 for c-C₄F₈, 9,200 for C₂F₆).

It was recently proposed to replace SF₆ by trifluoroiodomethane (CF₃I) (Nakauchi et al., XVI International Conference on Gas Discharge and their Applications, China, 11-15 Sep. 2006, [1]). Indeed, CF₃I has a higher dielectric strength than that of SF₆, both in a homogeneous field and in a heterogeneous field, with a GWP of less than 5 and an atmospheric residence time of 0.005 years.

Unfortunately, in addition to the fact that CF₃I is expensive, it has an average occupational exposure level (VME) of the order of 3 to 4 ppm and is classified among the category 3 carcinogenic, mutagenic and reprotoxic (CMR) substances, which is prohibitive for use on an industrial scale.

It has also been proposed to use hybrid insulation, combining a gaseous insulation, for example by dry air, nitrogen or CO₂, with a solid insulation. As described in the European patent application published as n^{o} 1 724 802, [2], this solid isolation consists, for example, in covering the electrically live parts which have a high electrical gradient by a resin of the epoxide or comparable type, enabling the field to which the electrically live parts are subjected to be reduced.

However, the insulation obtained in this manner is not equivalent to that provided by SF₆ and the use of these hybrid systems requires that the volume of the electrical devices is increased compared to the volume permitted through SF₆ insulation.

Concerning the extinction of electric arcs without SF₆, there are different it solutions, namely extinction in oil, extinction in ambient air and extinction with a vacuum bottle.

However, oil extinction devices have the major disadvantage that they may explode in the event that the extinction is unsuccessful or there is an internal fault. Ambient air extinction devices generally have large dimensions, are expensive and are sensitive to the environment (moisture and pollution), whereas devices, notably switch disconnectors, using extinction with a vacuum bottle are very expensive and few and far between in the market.

No truly satisfactory alternative to SF₆ currently exists.

The Inventors therefore set themselves the aim of finding a gas which, whilst having satisfactory properties of electrical insulation and extinction of electric arcs, has a low or zero environmental impact, and which is not, furthermore, toxic for humans and animals.

They also set themselves the aim that the use of this gas in currently commercially available medium- or high-voltage electrical devices, instead of SF₆, with which these devices are generally filled, should lead to performance, in terms of electrical insulation and/or extinction of electric arcs, equivalent to those procured by SF₆, over the entire range of service temperatures of these devices, or should require, to obtain such performance, merely that minor structural modifications are made to said devices.

### DESCRIPTION OF THE INVENTION

These aims, and others, are attained by the invention which proposes, firstly, the use of a mixture comprising a fluoroketone and a carrier gas as an electrical insulation medium and/or medium for extinction of electric arcs in a medium- or high-voltage electrical device, which use is characterised in that the fluoroketone is decafluoro-2-methylbutan-3-one and is present in the mixture in a molar percentage at least equal to 95% molar percentage M determined by the following formula (I):

M=(P_{C5K}/Pₘᵢₓₜᵤᵣₑ)×100 (I)

where:
Pₘᵢₓₜᵤᵣₑ represents the pressure, expressed in kilopascals, of the mixture at 20° C. in the electrical device; and
P_{C5K} represents the pressure, expressed in kilopascals, which is equivalent at 20° C. to the saturation vapour pressure which decafluoro-2-methyl-butan-3-one has at the minimum service temperature of the electrical device, where P_{C5K} is determined by the formula (II) below:

P_{C5K}=(PVS_{C5K}×293)/Tₘᵢₙᵢₘᵤₘ (II)

where:
PVS_{C5K} represents the saturation vapour pressure, expressed in kilopascals, which decafluoro-2-methylbutan-3-one has at the minimum service temperature of the electrical device; and
Tₘᵢₙᵢₘᵤₘ represents the minimum service temperature of the electrical device, expressed in Kelvin.

Thus, according to the invention, a mixture including decafluoro-2-methylbutan-3-one and a carrier gas (which will also be called a “dilution gas” in what follows, since the essential function of this gas is to dilute this fluoroketone) is used as the electrical insulation medium and/or medium for extinction of electric arcs.

Decafluoro-2-methylbutan-3-one has the molecular formula C₅F₁₀O and the semi-developed formula CF₃—CO—CF—(CF₃)₂. It will called more simply C5K in what follows.

In addition, according to the invention, C5K is present in the mixture used in a molar percentage which is at least equal to 95% of molar percentage M (i.e. at least equal to 0.95 times this percentage) of C5K, meaning that it is certain that at the device's minimum service temperature the proportion of C5K in the part of this mixture, which is in the gaseous state, is at a maximum, bearing in mind that the mixture may be fully or partly in the gaseous state.

Such a maximum proportion of C5K gives, at the minimum service temperature of the electrical device, i.e. under the most unfavourable conditions of use of this device, optimal electrical insulation and/or electric arc extinction properties, close to those of SF₆.

Table I below indicates the saturation vapour pressures, noted PVS_{C5K}, which C5K has at the temperatures of 0, −5, −10, −15, −20, −25, −30, −35 and −40° C., which are the minimum service temperatures typically found for medium- and high-voltage electrical devices.

It also indicates the pressure values, noted P_{C5K}, which correspond at 20° C. to these saturation vapour pressures, and which are obtained by applying formula (II) above.

TABLE I

| Temperatures | PVS_{C5K} | P_{C5K} |
|---|---|---|
| 0° C. | 41.3 kPa | 44.3 kPa |
| (273.15 K) | | |
| −5° C. | 33.6 kPa | 36.7 kPa |
| (268.15 K) | | |
| −10° C. | 27.1 kPa | 30.2 kPa |
| (263.15 K) | | |
| −15° C. | 21.7 kPa | 24.7 kPa |
| (258.15 K) | | |
| −20° C. | 17.3 kPa | 20.0 kPa |
| (253.15 K) | | |
| −25° C. | 13.6 kPa | 16.0 kPa |
| (248.15 K) | | |
| −30° C. | 10.6 kPa | 12.7 kPa |
| (243.15 K) | | |
| −35° C. | 8.1 kPa | 10.0 kPa |
| (238.15 K) | | |
| −40° C. | 6.2 kPa | 7.8 kPa |
| (233.15 K) | | |

If the electrical device is a medium-voltage device, the fact that C5K may be present in this device partially in the gaseous state and partially in the liquid state does not pose any standards-related problems. In this case, it is therefore possible to use a mixture in which C5K is present in a molar percentage higher than molar percentage M.

In a medium-voltage electrical device, C5K is therefore preferably present in the mixture in a molar percentage of between 95% and 130% and, better still, between 95% and 110%, and ideally between 99% and 110% of molar percentage M. In other words, C5K is preferentially present in the mixture in a molar percentage which is between 0.95 time and 1.3 time and, better still between 0.95 time and 1.1 time, and ideally between 0.99 time and 1.1 time molar percentage M.

Conversely, if the electrical device is a high-voltage electrical device of the metal-clad substation (PSEM) type, it is desirable, in order that it may satisfy the IEC standards currently in force, that C5K is present in this device exclusively, or almost exclusively, in the gaseous state, across the range of the service temperatures of this device.

In a high-voltage electrical device of the PSEM type, it is therefore preferred that C5K should be present in the mixture in a molar percentage which does not exceed 100% of molar percentage M (i.e. this molar percentage) in order that it has no liquefaction phase. The percentage of C5K is then between 95% and 100% of molar percentage M (i.e. between 0.95 time this molar percentage and this molar percentage).

In accordance with the invention, the dilution gas is preferably chosen from among the gases which have, firstly, a very low boiling point, i.e. typically equal to or less than −50° C. at standard pressure and, secondly, a dielectric strength which is at least equal to that of carbon dioxide under strictly identical testing conditions (same equipment, same geometrical configuration, same operational settings, etc.) to those used to measure the dielectric strength of said gas.

In addition, it is preferred that the dilution gas is not toxic, i.e. that it should not be classed among the substances considered to be carcinogenic, mutagenic and/or toxic for reproduction by Regulation (EC) n^{o} 1272/2008 of the European Parliament and of the Council of 16 Dec. 2008, and that it should also have a low GWP, i.e. typically at most equal to 500.

Gases which have all these properties are, for example, air, preferably dry air (GWP of 0), nitrogen (GWP of 0), nitrous oxide (GWP of 310), carbon dioxide (GWP of 1), mixtures of carbon dioxide and oxygen in a volume ratio ranging from 90/10 to 97/3, and mixtures of these different gases.

Preferably, the dilution gas is air, preferably dry air, carbon dioxide or a mixture of these gases.

Another object of the invention is a medium- or high-voltage electrical device which comprises a sealed enclosure containing electrical components and a mixture comprising a fluoroketone and a carrier gas for electrical insulation and/or extinction of electric arcs which may be produced within this device, characterised in that the fluoroketone is decafluoro-2-methylbutan-3-one and is present in the mixture in a molar percentage at least equal to 95% of molar percentage M determined by the following formula (I):

M=(P_{C5K}/Pₘᵢₓₜᵤᵣₑ)×100 (I)

where:
Pₘᵢₓₜᵤᵣₑ represents the pressure, expressed in kilopascals, of the mixture at 20° C. in the electrical device; and
P_{C5K} represents the pressure, expressed in kilopascals, which is equivalent at 20° C. to the saturation vapour pressure which decafluoro-2-methylbutan-3-one has at the minimum service temperature of the electrical device, where P_{C5K} is determined by the formula (II) below:

P_{C5K}=(PVS_{C5K}×293)/Tₘᵢₙᵢₘᵤₘ (II)

where:
PVS_{5K} represents the saturation vapour pressure of decafluoro-2-methylbutan-3-one at the minimum service temperature of the electrical device, expressed in kilopascals; and
Tₘᵢₙᵢₘᵤₘ represents the minimum service temperature of the electrical device, expressed in Kelvin.

The characteristics of the mixture including C5K and the carrier gas which is present in this device are such as previously described concerning the use of this mixture.

In accordance with the invention, this electrical device may be, firstly, a gas insulated transformer such as, for example, a power transformer or measurement transformer.

It may also be a gas-insulated line, either overhead or buried, or a set of busbars for transporting or distributing electricity.

Lastly, it may also be an electrical connection/disconnection device (also called switchgear) such as, for example, a circuit breaker, a switch, a disconnector, a switch-fuse set, an earthing switch or a contactor.

Other characteristics and advantages of the invention will come to light in the additional description below.

It is self-evident, however, that this additional description is given only to illustrate the object of the invention and in no way constitutes a limitation of this object.

### BRIEF DESCRIPTION OF THE DRAWINGS

FIG. 1 illustrates, in the form of a curve, the changes of the normalised dielectric strength of a mixture of C5K and CO₂ as a function of the molar percentage of C5K of this mixture.

FIG. 2 illustrates, in the form of a curve, the changes of the normalised dielectric strength of a mixture of C5K and dry air as a function of the molar percentage of C5K of this mixture.

FIG. 3 illustrates, in the form of a bar chart, the changes of the dielectric strength in a homogeneous field obtained for a mixture of C5K and dry air as a function of the molar percentage of C5K of this mixture; in this diagram, the dielectric strength of the C5K/dry air mixture is expressed as a percentage of the dielectric strength obtained under the same temperature and pressure conditions with SF₆, whereas the molar percentage of C5K is expressed as a percentage of molar percentage M as previously defined.

### DETAILED DESCRIPTION OF PARTICULAR EMBODIMENTS

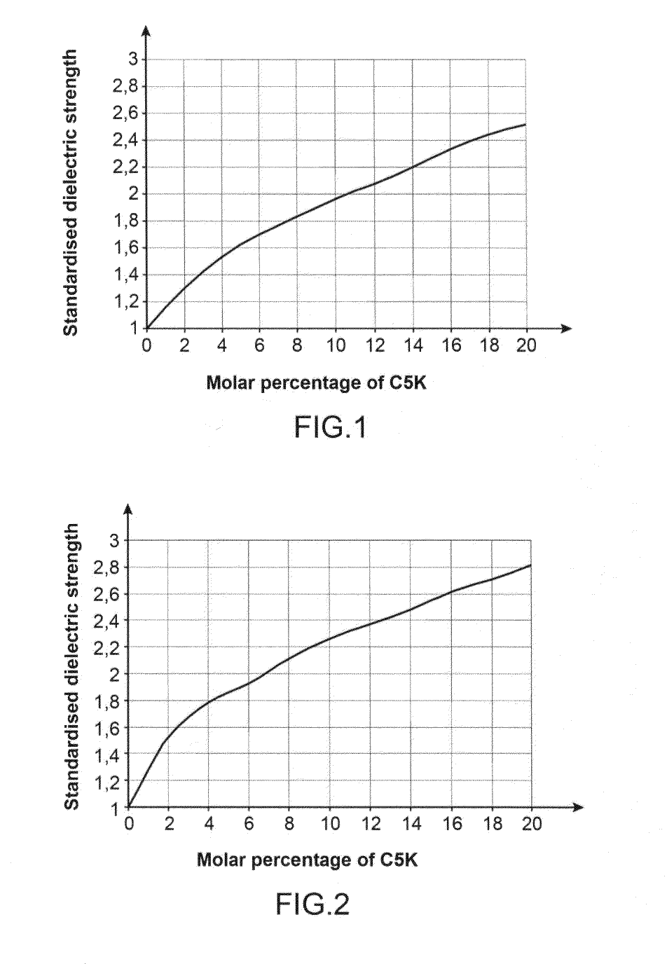

Reference is firstly made to FIGS. 1 and 2 which illustrate, in the form of curves, the changes of normalised dielectric strength of mixtures consisting respectively of C5K and of CO₂ (FIG. 1), and of C5K and of dry air (FIG. 2) as a function of the molar percentage of C5K of these mixtures.

In the foregoing and in what follows, the term “normalised dielectric strength” of a mixture consisting of C5K and of a carrier gas or dilution gas is understood to mean the dielectric strength of this mixture related to the dielectric strength of the carrier gas or dilution gas when this gas is used under the same conditions.

The changes of the normalised dielectric strength illustrated in FIGS. 1 and 2 therefore show the gain, in terms of dielectric strength, which is directly related to the increase of molar percentage of C5K of the C5K/CO₂ (FIGS. 1) and C5K/dry air mixtures (FIG. 2).

It should be noted that the values of dielectric strength given in FIGS. 1 and 2 are given for a configuration with a homogeneous electrical field.

By combining the data of table I above and the data of FIGS. 1 and 2, it is therefore possible to forecast that, for an electrical device the minimum service temperature of which will be −30° C., the use of C5K/CO₂ and C5K/dry air mixtures having a pressure equal to 100, 200, 300, 400 or 500 kPa at 20° C. and a partial pressure of C5K of 12.7 kPa at 20° C. (i.e. corresponding to the value of P_{C5K} given in table I above for a temperature of −30° C.), will lead to the normalised dielectric strength values given in table II below.

TABLE II

| | | | Normalised dielectric | |
|---|---|---|---|---|
| | | Molar | strength | |
| Pressure of the | Partial | percentage of | | C5K/dry |
| mixture at | pressure of | C5K in the | C5K/CO₂ | air |
| 20° C. | C5K at 20° C. | mixture | mixture | mixture |
| 100 kPa | 12.7 kPa | 12.7% | 2.1 | 2.4 |
| 200 kPa | | 6.4% | 1.7 | 2.0 |
| 300 kPa | | 4.2% | 1.5 | 1.8 |
| 400 kPa | | 3.2% | 1.4 | 1.6 |
| 500 kPa | | 2.5% | 1.3 | 1.5 |

In the same way, it is possible to forecast that, for an electrical device the minimum service temperature of which will be −15° C., the use of C5K/CO₂ and C5K/dry air mixtures having a pressure equal to 100, 200, 300, 400 or 500 kPa at 20° C. and a partial pressure of C5K of 24.7 kPa at 20° C. (i.e. corresponding to the value of P_{C5K} given in table I above for a temperature of −15° C.), will lead to the normalised dielectric strength values given in table III below.

TABLE III

| | | | Normalised dielectric | |
|---|---|---|---|---|
| | | Molar | strength | |
| Pressure of the | Partial | percentage of | | C5K/dry |
| mixture at | pressure of | C5K in the | C5K/CO₂ | air |
| 20° C. | C5K at 20° C. | mixture | mixture | mixture |
| 100 kPa | 24.7 kPa | 24.7% | 2.8 | 3.0 |
| 200 kPa | | 12.4% | 2.1 | 2.4 |
| 300 kPa | | 8.2% | 1.9 | 2.2 |
| 400 kPa | | 6.2% | 1.7 | 2.0 |
| 500 kPa | | 4.9% | 1.6 | 1.9 |

It is also possible to forecast that, for an electrical device the minimum service temperature of which will be −5° C., the use of C5K/CO₂ and C5K/dry air mixtures having a pressure equal to 100, 200, 300, 400 or 500 kPa at 20° C. and a partial pressure of C5K of 36.7 kPa at 20° C. (i.e. corresponding to the value of P_{C5K} given in table I above for a temperature of −5° C.), will lead to the normalised dielectric strength values given in table IV below.

TABLE IV

| | | | Normalised dielectric | |
|---|---|---|---|---|
| | | Molar | strength | |
| Pressure of the | Partial | percentage of | | C5K/dry |
| mixture at | pressure of | C5K in the | C5K/CO₂ | air |
| 20° C. | C5K at 20° C. | mixture | mixture | mixture |
| 100 kPa | 36.7 kPa | 36.7% | 3.2 | 3.8 |
| 200 kPa | | 18.4% | 2.4 | 2.7 |
| 300 kPa | | 12.2% | 2.1 | 2.4 |
| 400 kPa | | 9.2% | 1.9 | 2.2 |
| 500 kPa | | 7.3% | 1.8 | 2.1 |

### EXAMPLE 1

### Application to Medium Voltage

Two devices of the GIS (Gas Insulated Switchgear) type—hereinafter devices 1 and 2—of rated voltage 24 kV, and which are intended to be used at a minimum temperature of −15° C., are filled with a mixture of C5K and CO₂.

Device 1 has a structure strictly identical to the structure of the device which is sold with reference FBX 24 kV by Schneider Electric, and which is filled, in its current commercial version, with SF₆ at a pressure of 130 kPa.

Device 2 differs from device 1 in that its bypasses have been sheathed, by a heat-shrinkable sheath enabling striking between them to be prevented, and in that an electrical field splitter has been added to it.

Since devices 1 and 2 are intended to be used at a minimum temperature of −15° C., they are filled with the C5K/CO₂ mixture such that:
the total pressure of the C5K/CO₂ mixture is equal in these devices to 130 kPa at 20° C.;
the partial pressure of C5K is equal in these devices to 24.7 kPa at 20° C.;
   giving a molar percentage of C5K equal to 19%.

To accomplish this filling, each device is firstly positioned in a sealed case, and a vacuum is then applied (0-0.1 kPa) both to the interior of the device and between the device and the wall of the case, so as to prevent the walls of the device from being deformed.

The first stage is to cover the inner wall of the tank of the device with C5K by injecting into this tank 0.3 to 0.5 kPa of pure CK5, using the “gas” outlet of a tank of C5K which has a “gas” outlet and a “liquid” outlet, and which has previously been gently heated to accelerate the flow rate of the C5K.

The tank then continues to be filled by means of a gas mixtureer fitted with two bubblers, whilst maintaining the ratio between the pressures at 20° C. of the C5K and of the CO₂ at 19% during the entire filling process, using a precision mass flowmeter. During this operation the C5K is placed in the two bubblers which are traversed by the pressurised CO₂ in order to reach full saturation.

Devices 1 and 2 filled in this manner are then subjected to dielectric strength tests:
when subjected a lightning impulse (wave of 1.2-50 μs) between phase and earth;
when subjected a lightning impulse (wave of 1.2-50 μs) over the operating distance;
at the industrial frequency (50 Hz-1 min) between phase and earth; and
at the industrial frequency (50 Hz-1 min) over the operating distance.

All these tests are undertaken in compliance with IEC standard 62271-200, at ambient temperature and at −15° C. (devices 1 and 2 being in this latter case positioned in a refrigerated enclosure).

The results of these tests are shown in table V below.

As a comparison, the dielectric strengths obtained under the same conditions for FBX 24 kV and sold are also given in this table.

TABLE V

| Type of dielectric | | | |
|---|---|---|---|
| strength test | FBX 24 kV | Device 1 | Device 2 |
| Lightning impulse | >125 kVc | 118 kVc | >125 kVc |
| between phase and earth | | | |
| Lightning impulse over | >145 kVc | >145 kVc | >145 kVc |
| the isolating distance | | | |
| Industrial frequency | >50 kV | >50 kV | >50 kV |
| between phase and earth | | | |
| Industrial frequency over | >60 kV | >60 kV | >60 kV |
| the isolating distance | | | |

This table shows that a medium-voltage electrical device which is filled with a C5K/CO₂ mixture in a 19/81 molar ratio has, in the range of temperatures from −15° C. to +50° C., performance equivalent, in terms of dielectric strength, to that which the same device has when it is filled with SF₆ at the same pressure, except with regards to the dielectric strength when subjected to a lightning impulse between phase and earth.

However, it also shows that a few minor structural modifications, such as sheathing its bypasses, and the addition of an electrical field splitter, are sufficient for this device also to have also a dielectric strength when subject to a lightning impulse between phase and earth equivalent to the strength which the same device has when it is filled with SF₆ at the same pressure.

Device 1 is also subjected to heating tests which are undertaken in accordance with IEC standard 62271-200.

These tests show that, when this device is traversed by a permanent current of 630 A RMS, the maximum heating values measured in the electrical contacts (which represent the hottest points) are only 1% higher than those obtained, under the same conditions, for the FBX 24 kV as sold, which is perfectly acceptable.

As a comparison, a device with a structure identical to that of the FBX 24 kV but which is filled with pure CO₂ has, for its part, maximum heating values which are 7.8% higher than those obtained for the FBX 24 kV as sold.

Device 1 is also subjected to breaking tests which are undertaken in accordance with IEC standard 60265-1.

These tests show that it is possible to undertake, with this device, more than 100 disconnections for a 400 ampere current, with a 24 kV rated voltage and a power factor of 0.7.

Insofar as these results are less good than the ones obtained with the FBX 24 kV as sold, since the latter enables more than 100 disconnections to be made, but for a 630 ampere current, with a 24 kV rated voltage and a power factor of 0.7, the breaking tests are repeated on device 1 after a part (washer) made of gas-producing material has been put in contact with the fixed electrical contacts of the switch, in this case PTFE filled with CeF₃ at 5% by mass, in the disconnection chamber of this device.

It is then possible to undertake, with this device, more than 100 disconnections for a 630 ampere current, with a 24 kV rated voltage and a power factor of 0.7.

Here again, by simpling making a minor structural modification, such as the addition of a gas-producing material of the fluorinated polymer type (for example PFA, FEP or PTFE) plus a fluorinated filler (for example CaF₂, CeF₃, CeF₄ or MgF₂), to device 1, equivalent performance, in terms of disconnection, to that of the same device when it is filled with SF₆ at the same pressure, are obtained.

### EXAMPLE 2

### Application to High Voltage

A device of the GIS type—hereinafter device 3—with a 145 kV rated voltage, and which is intended to be used at a minimum temperature of −30° C., is filled with a mixture of C5K and dry air.

Device 3 has a structure which is strictly identical to the structure of the device sold by Alstom Grid with reference B65 and which is filled with SF₆ in its current commercial version.

Since device 3 is intended to be used at a minimum temperature of −30° C., it is filled with the C5K/dry air mixture such that:
the total pressure of the C5K/dry air mixture is equal in this device to 500 kPa at 20° C.;
the partial pressure of C5K is equal in this device to 12.7 kPa at 20° C.;
   giving a molar percentage of C5K equal to 2.54%.

Device 3 is filled with the C5K/dry air mixture using the same procedure as that described in example 1, except that dry air is used instead of CO₂ and a ratio between the pressures at 20° C. of the C5K and of the dry air equal to 2.5% is used.

Device 3 filled in this manner is then subjected to dielectric strength tests at ambient temperature when subjected to lightning impulses (wave of 1.2-50 μs) with a positive wave and a negative wave in accordance with IEC standard 62271-1.

The results of these tests are shown in table VI below.

As a comparison, this table also shows the dielectric strengths obtained under the same conditions for a device of equally identical structure to that of the B65, but which has been filled with dry air at a pressure of 500 kPa.

TABLE VI

| Type of dielectric strength | Device filled with | |
|---|---|---|
| test | dry air | Device 3 |
| Lightning impulse with | 334 kV | 534 kV |
| positive wave | | |
| Lightning impulse with | 369 kV | 552 kV |
| negative wave | | |

This table shows that a high-voltage device which is filled with a C5K/dry air mixture in a 19/81 molar ratio has performance, in terms of dielectric strength, far superior to that of the same device when it is filled with dry air at the same pressure.

### EXAMPLE 3

### Influence of the Choice of the Molar Percentage of C5K in the Mixture on the Dielectric Strength of this Mixture

A series of devices of the same type as previously used device 1 are filled with a mixture of C5K and dry air (minimum service temperature: −15° C.; total pressure of the C5K/dry air mixture: 130 kPa) whilst varying, from one device to the next, the molar percentage of C5K in the mixture, such that this molar percentage is respectively equal to 0%, 31.2%, 64%, 95%, 100% and 146.8% of molar percentage M of C5K, which means that it can be certain that at −15° C. the proportion of C5K in the part of said C5K/dry air mixture, which is in the gaseous state, is at a maximum.

These devices are then subjected to dielectric strength tests in a homogeneous field, at ambient temperature, and the results obtained are compared with those obtained at the same temperature and for the same type of device when filled with SF₆ at a pressure of 130 kPa.

The results of these tests are shown in table VII below, in which the dielectric strength obtained with the C5K/dry air mixture is expressed as a percentage of the dielectric strength obtained with SF₆.

TABLE VII

| | | | Dielectric |
|---|---|---|---|
| | | Molar percentage | strength |
| Partial pressure of | Molar | of C5K in the | (compared to |
| C5K at 20° C. | percentage M | mixture | SF₆) |
| 0 kPa | 0% | 0% | 54% |
| | | (i.e. 0% of M) | |
| 7.8 kPa | 6% | 1.87% | 64% |
| | | (i.e. 31.2% of M) | |
| 16 kPa | 12.3% | 7.87% | 81% |
| | | (i.e. 64% of M) | |
| 23.75 kPa | 18.3% | 17.38% | 96% |
| | | (i.e. 95% of M) | |
| 25 kPa | 19.2% | 19.2% | 98% |
| | | (i.e. 100% of M) | |
| 36.7 kPa | 28.2% | 41.4% | 102% |
| | | (i.e. 146.8% of M) | |

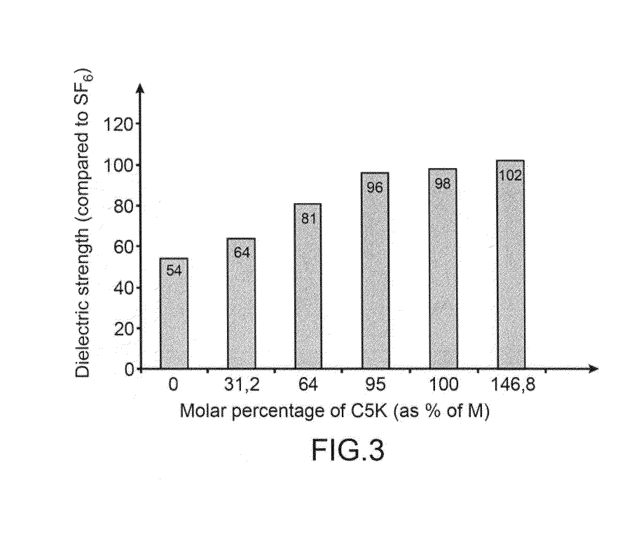

The results of these tests are also illustrated, in the form of a bar chart, in FIG. 3, in which the following are given:
in the abscissa, the molar percentage of C5K in the C5K/dry air mixture, expressed as a percentage of molar percentage M; and
in the ordinate, the dielectric strength obtained with the C5K/dry air mixture, expressed as percentage of the strength obtained with SF₆.

Table VII and FIG. 3 clearly confirm that, in order to obtain a dielectric strength at least equal to 95% of that obtained with SF₆, mixtures of C5K and a carrier gas such as dry air should be used, in which C5K is present at a molar percentage at least equal to 95% of molar percentage M of C5K, which enables it to be guaranteed that at the minimum service temperature of the electrical device the proportion of C5K in the part of the said C5K/dry air mixture which is in the gaseous state is at a maximum.

### CITED REFERENCES

[1] S. Nakauchi, D. Tosu, S. Matsuoka, A. Kumada and K Hidaka, “Breakdown characteristics measurement of non-uniform field gap in SF₆—N₂, CF₃I—N₂ and CF₃I—CO₂ gas mixtures by using square pulse voltage”, XVI International Conference on Gas Discharge and their Applications, China, 11-15 Sep. 2006.
[2] EP-A-1 724 802.

1. A process, comprising mixing a fluoroketone with a carrier gas to form a mixture which is suitable as an electrical insulation medium and/or a medium for extinction of electric arcs in a medium-voltage electrical device,
wherein:
the fluoroketone is decafluoro-2-methylbutan-3-one and is present in the mixture in a molar percentage at least equal to 95% of a molar percentage M determined by formula (I):
M=(P_{C5K}/Pₘᵢₓₜᵤᵣₑ)×100 (1);
where:
Pₘᵢₓₜᵤᵣₑ represents a pressure, expressed in kilopascals, of the mixture at 20° C. in the electrical device;
P_{C5K} represents a pressure, expressed in kilopascals, which is equivalent at 20° C. to a saturation vapor pressure of the decafluoro-2-methylbutan-3-one at a minimum service temperature of the electrical device, where P_{C5K} is determined by formula (II):
P_{C5K}=(PVS_{C5K}×293)/Tₘᵢₙᵢₘᵤₘ
PVS_{C5K} represents the saturation vapor pressure of the decafluoro-2-methylbutan-3-one at the minimum service temperature of the electrical device, expressed in kilopascals; and
Tₘᵢₙᵢₘᵤₘ represents the minimum service temperature of the electrical device, expressed in Kelvin.

2. The process according to claim 1, wherein the decafluoro-2-methylbutan-3-one is present in the mixture in a molar percentage is between 95% and 130% of the molar percentage M.

3. The process according to claim 2, wherein the decafluoro-2-methylbutan-3-one is present in the mixture in a molar percentage between 99% and 110% of the molar percentage M.

4. The process according to claim 1, wherein the decafluoro-2-methylbutan-3-one is present in the mixture in a molar percentage between 95% and 100% of the molar percentage M.

5. The process according to claim 1, wherein the carrier gas is selected from the group consisting of air, nitrogen, nitrous oxide, carbon dioxide, a mixture of carbon dioxide and oxygen in a volume ratio of between 90/10 and 97/3, and a mixture of these gases.

6. A medium-voltage electrical device, comprising a sealed enclosure comprising electrical components and a mixture comprising a fluoroketone and a carrier gas for electrical insulation and/or extinction of the electric arcs which are produced within this device, wherein:
the fluoroketone is decafluoro-2-methylbutan-3-one and is present in the mixture in a molar percentage at least equal to 95% of a molar percentage M determined by the formula (I):
M=(P_{C5K}/Pₘᵢₓₜᵤᵣₑ)×100 (I);
Pₘᵢₓₜᵤᵣₑ represents a pressure, expressed in kilopascals, of the mixture at 20° C. in the electrical device;
P_{C5K} represents a pressure, expressed in kilopascals, which is equivalent at 20° C. to a saturation vapor pressure of the decafluoro-2-methylbutan-3-one at a minimum service temperature of the electrical device, where P_{C5K} is determined by formula (II):
P_{C5K}=(PVS_{C5K}×293)/Tₘᵢₙᵢₘᵤₘ (II);
PVS_{C5K} represents the saturation vapor pressure of the decafluoro-2-methylbutan-3-one at the minimum service temperature of the electrical device, expressed in kilopascals; and
Tₘᵢₙᵢₘᵤₘ represents the minimum service temperature of the electrical device, expressed in Kelvin.

7. A device according to claim 6, wherein the decafluoro-2-methylbutan-3-one is present in the mixture in a molar percentage which is between 95% and 130% of the molar percentage M.

8. A device according to claim 7, wherein the decafluoro-2-methylbutan-3-one is present in the mixture in a molar percentage which is between 99% and 110% of the molar percentage M.

9. A device according to claim 6, wherein the decafluoro-2-methylbutan-3-one is present in the mixture in a molar percentage which is between 95% and 100% of the molar percentage M.

10. A device according to claim 6, wherein the carrier gas is selected from the group consisting of air, nitrogen, nitrous oxide, carbon dioxide, a mixture of carbon dioxide and oxygen in a volume ratio of between 90/10 and 97/3, and a mixture of these gases.

11. A device according to claim 6, which is a gas-insulated transformer, a gas-insulated line for transporting or distributing of electricity, or an electrical connection/disconnection device.
